(19) United States
(12) Patent Application Publication
(10) Pub. No.: US 2017/0254217 A1
(43) Pub. Date: Sep. 7, 2017

(54) Dry Detergent For Cleaning Gas Turbine Engine Components

(71) Applicant: General Electric Company, Schenectady, NY (US)

(72) Inventors: Michael Edward Eriksen, Cincinnati, OH (US); Ambarish Jayant Kulkarni, Glenville, NY (US); Nicole Jessica Tibbetts, Delanson, NY (US)

(21) Appl. No.: 15/057,168

(22) Filed: Mar. 1, 2016

(51) Int. Cl. F01D 25/00; C11D 7/02; C11D 17/06; B08B 9/00; B08B 3/04

(52) U.S. Cl. CPC F01D 25/002; B08B 9/00; B08B 3/04; C11D 17/06; C11D 7/02; F05D 2220/32

(57) ABSTRACT

The present disclosure is directed to a method for in-situ (e.g. on-wing) cleaning one or more components of a gas turbine engine. The method includes injecting a dry detergent into the gas turbine engine. Further, the dry detergent contains a plurality of detergent particles having varying particle sizes. More specifically, the plurality of detergent particles includes a first set of particles having a median particle diameter within a first micron range and a second set of particles having a median particle diameter within a second micron range. Further, a median of the second micron range is larger than a median of the first micron range. In addition, the method includes circulating the dry detergent through at least a portion of the gas turbine engine so as to clean the one or more components thereof.

### FIELD OF THE INVENTION

The present subject matter relates generally to gas turbine engines, and more particularly, the present subject matter relates to a dry detergent configured for in-situ cleaning of gas turbine engine components.

### BACKGROUND OF THE INVENTION

A gas turbine engine generally includes, in serial flow order, a compressor section, a combustion section, a turbine section and an exhaust section. In operation, air enters an inlet of the compressor section where one or more axial or centrifugal compressors progressively compress the air until it reaches the combustion section. Fuel is mixed with the compressed air and burned within the combustion section to provide combustion gases. The combustion gases are routed from the combustion section through a hot gas path defined within the turbine section and then exhausted from the turbine section via the exhaust section.

In particular configurations, the turbine section includes, in serial flow order, a high pressure (HP) turbine and a low pressure (LP) turbine. The HP turbine and the LP turbine each include various rotatable turbine components such as turbine rotor blades, rotor disks and retainers, and various stationary turbine components such as stator vanes or nozzles, turbine shrouds, and engine frames. The rotatable and stationary turbine components at least partially define the hot gas path through the turbine section. As the combustion gases flow through the hot gas path, thermal energy is transferred from the combustion gases to the rotatable and stationary turbine components.

During operation, environmental particulate accumulates on engine components. Such accumulation can lead to reduced cooling effectiveness of the components and/or corrosive reaction with the metals and/or coatings of the engine components. Thus, particulate build-up can lead to premature distress and/or reduced engine life.

Accordingly, the present disclosure is directed to a cleaning detergent and method of using same that addresses the aforementioned issues. More specifically, the present disclosure is directed to a dry detergent having varying-sized abrasive detergent particles that are particularly useful for in-situ cleaning of gas turbine engine components.

### BRIEF DESCRIPTION OF THE INVENTION

Aspects and advantages of the invention will be set forth in part in the following description, or may be obvious from the description, or may be learned through practice of the invention.

In one aspect, the present disclosure is directed to a method for in-situ (e.g. on-wing) cleaning one or more components of a gas turbine engine. The method includes injecting a dry detergent into the gas turbine engine. The dry detergent includes a plurality of particles having varying particle sizes. More specifically, the plurality of detergent particles includes a first set of particles having a median particle diameter within a first micron range and a second set of particles having a median particle diameter within a second micron range. Further, a median or average of the second micron range is larger than a median of the first micron range. In addition, the method includes circulating the dry detergent through at least a portion of the gas turbine engine so as to clean the one or more components thereof.

In another aspect, the present disclosure is directed to a dry detergent for in-situ cleaning one or more components of a gas turbine engine. The dry detergent includes a plurality of detergent particles having varying particle sizes. More specifically, the plurality of detergent particles may include a first set of particles having a median particle diameter within a first micron range and a second set of particles having a median particle diameter within a second micron range. Further, a median of the second micron range is larger than a median of the first micron range. Thus, the first set of particles is configured to deposit on surfaces of the one or more components. In addition, the second set of particles is configured to abrasively clean the one or more components of the gas turbine engine. It should be understood that the dry detergent may further include any of the additional features as described herein.

In yet another aspect, the present disclosure is directed to a method for in-situ cleaning one or more components of a gas turbine engine. The method includes providing a dry detergent into the gas turbine engine. The dry detergent includes a plurality of detergent particles having varying particle sizes. The plurality of detergent particles includes a first set of particles having a median particle diameter equal to or less than 10 microns and a second set of particles having a median particle diameter equal to or greater than 40 microns. Thus, the method also includes circulating the first set of particles through one or more cooling passageways of the components of the gas turbine engine and circulating the second set of particles across one or more surfaces of the components.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic cross-sectional view of one embodiment of a gas turbine engine according to the present disclosure;

FIG. 2 illustrates a flow diagram of one embodiment of a method for in-situ cleaning of one or more components of a gas turbine engine according to the present disclosure;

FIG. 3 illustrates a partial, cross-sectional view of one embodiment of a gas turbine engine, particularly illustrating a dry detergent being injected into the engine at a plurality of locations according to the present disclosure; and

FIG. 4 illustrates a flow diagram of another embodiment of a method for in-situ cleaning of one or more components of a gas turbine engine according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Generally, the present disclosure is directed to a dry detergent that is particularly useful for in-situ or on-wing cleaning of gas turbine engine components. The dry detergent is formed from a plurality of detergent particles having varying particle sizes. More specifically, the plurality of detergent particles may include a first set of particles having a median particle diameter within a first micron range and a second set of particles having a median particle diameter within a second micron range. Further, a median or average of the second micron range may be larger than a median of the first micron range. For example, the median particle diameter of the first set of particles may be equal to or less than 10 microns, whereas the median particle diameter for the second set of particles may be equal to or greater than 40 microns. Thus, the method includes injecting the dry detergent into the gas turbine engine, e.g. via an inlet or port thereof. In addition, the method includes circulating the dry detergent through at least a portion of the gas turbine engine so as to clean one or more components thereof. Accordingly, the varying particle sizes are configured to clean the varying surfaces of the turbine components.

The present disclosure provides various advantages not present in the prior art. For example, gas turbine engines according to present disclosure can be cleaned on-wing, in-situ, and/or off-site. Further, the cleaning methods of the present disclosure provide simultaneous mechanical and chemical removal of particulate deposits in cooling passageways of gas turbine engines. In addition, the system and method of the present disclosure improves cleaning effectiveness and has significant implications for engine time on-wing durability.

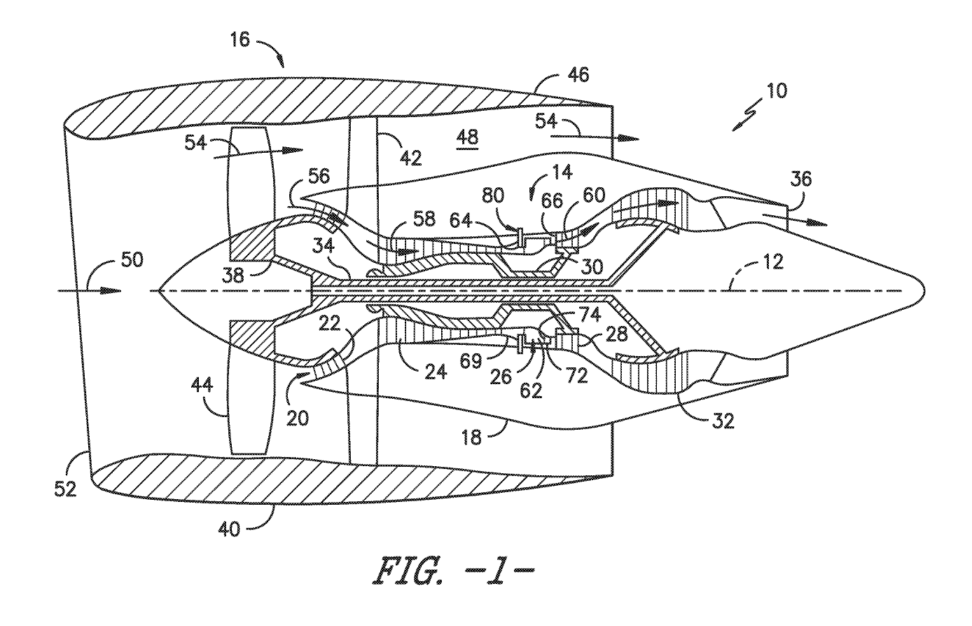

Referring now to the drawings, FIG. 1 illustrates a schematic cross-sectional view of one embodiment of a gas turbine engine 10 (high-bypass type) according to the present disclosure. As shown, the gas turbine engine 10 has an axial longitudinal centerline axis 12 therethrough for reference purposes. Further, as shown, the gas turbine engine 10 preferably includes a core gas turbine engine generally identified by numeral 14 and a fan section 16 positioned upstream thereof. The core engine 14 typically includes a generally tubular outer casing 18 that defines an annular inlet 20. The outer casing 18 further encloses and supports a booster 22 for raising the pressure of the air that enters core engine 14 to a first pressure level. A high pressure, multi-stage, axial-flow compressor 24 receives pressurized air from the booster 22 and further increases the pressure of the air. The pressurized air flows to a combustor 26, where fuel is injected into the pressurized air stream and ignited to raise the temperature and energy level of the pressurized air. The high energy combustion products flow from the combustor 26 to a first (high pressure) turbine 28 for driving the high pressure compressor 24 through a first (high pressure) drive shaft 30, and then to a second (low pressure) turbine 32 for driving the booster 22 and the fan section 16 through a second (low pressure) drive shaft 34 that is coaxial with the first drive shaft 30. After driving each of the turbines 28 and 32, the combustion products leave the core engine 14 through an exhaust nozzle 36 to provide at least a portion of the jet propulsive thrust of the engine 10.

The fan section 16 includes a rotatable, axial-flow fan rotor 38 that is surrounded by an annular fan casing 40. It will be appreciated that fan casing 40 is supported from the core engine 14 by a plurality of substantially radially-extending, circumferentially-spaced outlet guide vanes 42. In this way, the fan casing 40 encloses the fan rotor 38 and the fan rotor blades 44. The downstream section 46 of the fan casing 40 extends over an outer portion of the core engine 14 to define a secondary, or bypass, airflow conduit 48 that provides additional jet propulsive thrust.

From a flow standpoint, it will be appreciated that an initial airflow, represented by arrow 50, enters the gas turbine engine 10 through an inlet 52 to the fan casing 40. The airflow passes through the fan blades 44 and splits into a first air flow (represented by arrow 54) that moves through the conduit 48 and a second air flow (represented by arrow 56) which enters the booster 22.

The pressure of the second compressed airflow 56 is increased and enters the high pressure compressor 24, as represented by arrow 58. After mixing with fuel and being combusted in the combustor 26, the combustion products 60 exit the combustor 26 and flow through the first turbine 28. The combustion products 60 then flow through the second turbine 32 and exit the exhaust nozzle 36 to provide at least a portion of the thrust for the gas turbine engine 10.

Still referring to FIG. 1, the combustor 26 includes an annular combustion chamber 62 that is coaxial with the longitudinal centerline axis 12, as well as an inlet 64 and an outlet 66. As noted above, the combustor 26 receives an annular stream of pressurized air from a high pressure compressor discharge outlet 69. A portion of this compressor discharge air flows into a mixer (not shown). Fuel is injected from a fuel nozzle 80 to mix with the air and form a fuel-air mixture that is provided to the combustion chamber 62 for combustion. Ignition of the fuel-air mixture is accomplished by a suitable igniter, and the resulting combustion gases 60 flow in an axial direction toward and into an annular, first stage turbine nozzle 72. The nozzle 72 is defined by an annular flow channel that includes a plurality of radially-extending, circumferentially-spaced nozzle vanes 74 that turn the gases so that they flow angularly and impinge upon the first stage turbine blades of the first turbine 28. As shown in FIG. 1, the first turbine 28 preferably rotates the high-pressure compressor 24 via the first drive shaft 30, whereas the low-pressure turbine 32 preferably drives the booster 22 and the fan rotor 38 via the second drive shaft 34.

The combustion chamber 62 is housed within the engine outer casing 18 and fuel is supplied into the combustion chamber 62 by one or more fuel nozzles 80. More specifically, liquid fuel is transported through one or more passageways or conduits within a stem of the fuel nozzle 80.

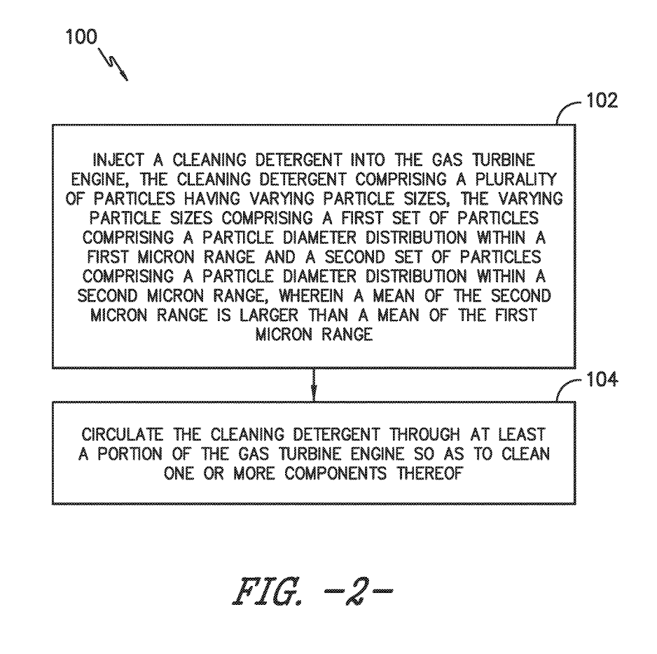

Referring now to FIG. 2, a flow diagram of one embodiment of a method 100 for in-situ cleaning one or more components of a gas turbine engine (e.g. such as the gas turbine engine 10 illustrated in FIG. 1) is illustrated. For example, in certain embodiments, the component(s) of the gas turbine engine 10 may include any of the components of the engine 10 as described herein, including but not limited to the compressor 24, the high-pressure turbine 28, the low-pressure turbine 32, the combustor 26, the combustion chamber 62, one or more nozzles 72, 80, one or more blades 44 or vanes 42, the booster 22, a casing 18 of the gas turbine engine 10, or similar.

Thus, as shown at 102, the method 100 may include injecting a dry detergent into the gas turbine engine 10, e.g. into any of the components thereof. More specifically, the step of injecting the dry detergent into the gas turbine engine 10 may include injecting the dry detergent into an inlet (e.g. inlet 20, 52 or 64) of the engine 10. Alternatively or in addition, as shown, the step of injecting the dry detergent into the gas turbine engine 10 may include injecting the dry detergent into one or more ports 82 of the engine 10. Further, the dry detergent may be injected into the engine 10 using any suitable means. More specifically, in certain embodiments, the dry detergent may be injected into the engine 10 using automatic and/or manual devices configured to pour, funnel, or channel substances into the engine 10.

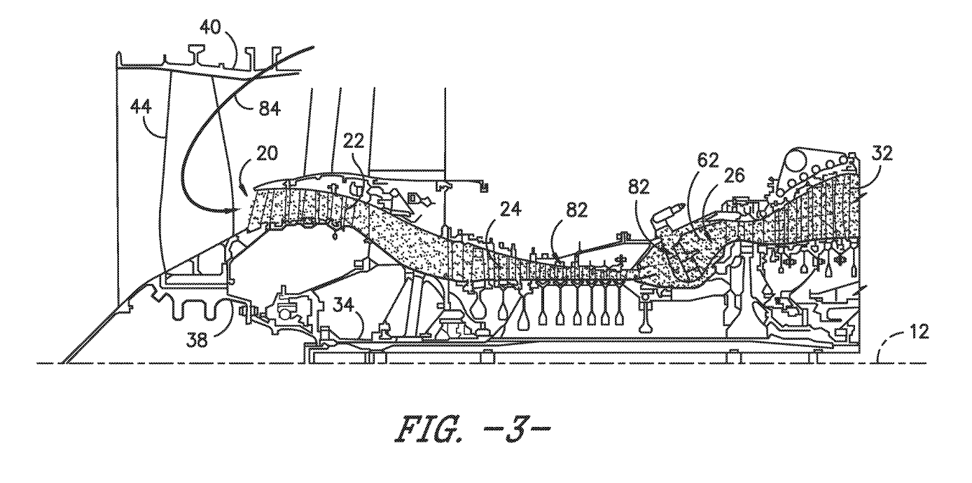

For example, referring now to FIG. 3, a partial, cross-sectional view of one embodiment of the gas turbine engine 10 according to the present disclosure is illustrated. As shown, the dry detergent (as indicated by arrow 84) may be injected into the engine 10 at a plurality of locations. More specifically, as shown, the dry detergent is injected to the inlet 20 of the engine 10. Further, as shown, the dry detergent 84 may be injected into one or more ports 82 of the engine 10. For example, as shown, the dry detergent 84 may be injected into a port 82 of the compressor 24 and/or a port 82 of the combustion chamber 62. Thus, the dry detergent particles are configured to flow through the engine 10 so as to clean one or more components configured therein.

The dry detergent 84 of the present disclosure may include any suitable composition now known or later developed in the art. For example, in one embodiment, the dry detergent particles may include a biodegradable citric and glycolic-acid composition including both ionic and non-ionic surfactants as well as corrosion inhibition properties such that the composition is compatible with all coatings and components both internal and external to the engine and compliant, at a minimum, with AMS1551, a specification for on-wing application. Furthermore, the detergent composition is configured to be compliant with the aforementioned specification without requiring a rinse step prior to firing the engine post-cleaning, demonstrating no pitting corrosion or intergranular attack to engine component parent metals or coating systems.

In addition, the particles of the dry detergent 84 may be detergent particles having varying particle sizes. For example, in certain embodiments, the plurality of detergent particles include a first set of particles having a median or average particle diameter within a first, smaller micron range and a second set of particles having a median particle diameter within a second, larger micron range. More specifically, as used herein, a “micron range” generally encompasses a particle diameter size range measured in micrometers. For example, in certain embodiments, the first set of particles may have a median particle diameter equal to or less than 20 microns, whereas the second set of particles may have a median particle diameter equal to or greater than 20 microns. More specifically, the first micron range may be equal to or less than 10 microns, whereas the second micron range may be equal to or greater than 30 microns, or more preferably equal to or greater than 40 microns. Thus, a median of the second micron range may be larger than a median or average of the first micron range.

Accordingly, as shown at 104, the method 100 may also include circulating the dry detergent 84 through at least a portion of the gas turbine engine 10 so as to clean one or more components thereof. More specifically, the smaller particles of the dry detergent can be carried into smaller areas of the engine 10, e.g. into the smaller cooling passageways, which are inaccessible to the larger particles. As such, the smaller detergent particles are configured to deposit at the desired cleaning locations (i.e. where dust previously deposited) and the larger particles are configured to abrasively clean the larger component surfaces.

More specifically, in certain embodiments, the step of circulating the dry detergent 84 through at least a portion of the gas turbine engine 10 may include motoring or running the engine 10 during injection of the dry detergent 84 so as to circulate the particles through the gas turbine engine 10 via airflow. Alternatively, the step of circulating the dry detergent 84 through at least a portion of the gas turbine engine 10 may include utilizing one or more external pressure sources to provide airflow that circulates the particles through the gas turbine engine 10. For example, in certain embodiments, the external pressure sources may include a fan, a blower, or similar.

In another embodiment, the method 100 may include activating the dry detergent 84 after circulating the particles through the gas turbine engine 10, e.g. via a fluid. More specifically, in certain embodiments, the dry detergent 84 may be activated by adding water or steam. In such embodiments, the method 100 may also include rinsing the dry detergent 84 out of the turbine 10 after the dry detergent 84 has been activated.

In yet another embodiment, the method 100 may also include injecting a fluid into the gas turbine engine 10 prior to injecting the dry detergent 84 into the gas turbine engine 10 so as to wet one or more surfaces of the components of the gas turbine engine 10. Such initial wetting of the turbine components can further assist cleaning of the components.

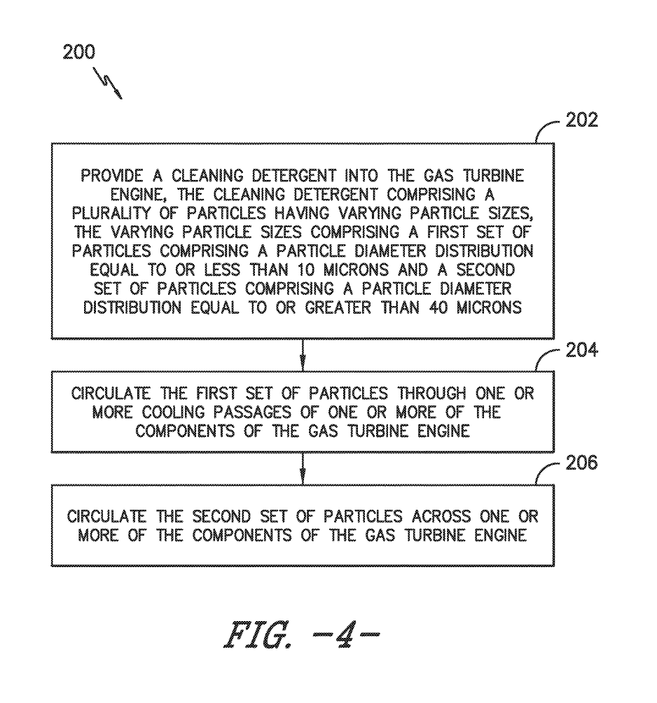

Referring now to FIG. 4, a flow diagram of another embodiment of a method 200 for in-situ or on-wing cleaning one or more components of a gas turbine engine 10 is illustrated. As shown at 202, the method 200 includes providing a dry detergent 84 into the gas turbine engine 10. As mentioned, the dry detergent 84 includes a plurality of detergent particles having varying particle sizes. More specifically, the plurality of detergent particles includes a first set of particles having a median particle diameter equal to or less than 10 microns and a second set of particles having a median particle diameter equal to or greater than 40 microns. Thus, as shown at 204, the method 200 also includes circulating the first set of particles through one or more cooling passageways of the components of the gas turbine engine 10. As shown at 206, the method 200 also includes circulating the second set of particles across one or more surfaces of the components of the gas turbine engine 10.

In another embodiment, the step of providing the dry detergent 84 into the gas turbine engine 10 may include injecting the dry detergent 84 into an inlet (e.g. inlets 20, 52, 64) of the gas turbine engine 10 or one or more ports 82 of the gas turbine engine 10. In additional embodiments, the step of circulating the first set of particles and the second set of particles through at least a portion of the engine 10 may include motoring or running the engine 10 during injection of the dry detergent 84 so as to provide airflow that circulates the detergent therethrough. Alternatively or in addition, the first and second sets of particles may be circulated through the engine 10 via one or more external pressure sources (e.g. a fan or blower) that provide airflow to circulate the detergent 84 through the gas turbine engine 10. Further, it should be understood that the first and second sets of particles of detergent may be injected into the engine 10 simultaneously (e.g. as a mixture or separately through different inlets or ports) or consecutively (e.g. one after the other).

In another embodiment, the method 200 may include activating the dry detergent 84 after circulating the first and second sets of particles through the gas turbine engine 10, e.g. via water or steam. In further embodiments, the method 200 may include rinsing the dry detergent 84 after activation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method for in-situ cleaning one or more components of a gas turbine engine, the method comprising:
injecting a dry detergent into the gas turbine engine, the dry detergent comprising a plurality of detergent particles having varying particle sizes, the plurality of detergent particles comprising a first set of particles having a median particle diameter within a first micron range and a second set of particles having a median particle diameter within a second micron range, wherein a median of the second micron range is larger than a median of the first micron range; and
circulating the dry detergent through at least a portion of the gas turbine engine so as to clean the one or more components thereof.

2. The method of claim 1, wherein the first set of particles comprises a median particle diameter equal to or less than 20 microns, and wherein the second set of particles comprises a median particle diameter equal to or greater than 20 microns.

3. The method of claim 2, wherein the first set of particles comprises a median particle diameter equal to or less than 10 microns, and wherein the second set of particles comprises a median particle diameter equal to or greater than 40 microns.

4. The method of claim 1, wherein injecting the dry detergent into the gas turbine engine further comprises injecting the dry detergent into at least one of an inlet of the gas turbine engine or one or more ports of the gas turbine engine.

5. The method of claim 4, wherein circulating the dry detergent through at least a portion of the gas turbine engine further comprises motoring the gas turbine engine during injection of the dry detergent so as to provide airflow that circulates the particles through the gas turbine engine.

6. The method of claim 4, wherein circulating the dry detergent through at least a portion of the gas turbine engine further comprises utilizing one or more external pressure sources to provide airflow that circulates the particles through the gas turbine engine.

7. The method of claim 1, further comprising activating, via a fluid, the dry detergent after circulating the dry detergent through at least a portion of the gas turbine engine, wherein the fluid comprises at least one of water or steam.

8. The method of claim 6, further comprising rinsing the dry detergent after activation.

9. The method of claim 1, wherein the one or more components of the gas turbine engine comprise at least one of a compressor, a high-pressure turbine, a low-pressure turbine, a combustor, a combustion chamber, a nozzle, one or more blades or vanes, a booster, or a casing of the gas turbine engine.

10. The method of claim 1, further comprising injecting a fluid into the gas turbine engine prior to injecting the dry detergent into the gas turbine engine so as to wet one or more surfaces of the components of the gas turbine engine.

11. A dry cleaning detergent for in-situ cleaning of one or more components of a gas turbine engine, the dry cleaning detergent comprising:
a plurality of detergent particles having varying particle sizes, the plurality of detergent particles comprising:
a first set of particles having a median particle diameter within a first micron range, the first set of particles configured to deposit on surfaces of the one or more components, and
a second set of particles having a median particle diameter within a second micron range, a median of the second micron range being larger than a median of the first micron range, the second set of particles configured to abrasively clean the one or more components of the gas turbine engine.

12. The cleaning detergent of claim 11, wherein the first set of particles comprises a median particle diameter equal to or less than 10 microns, and wherein the second set of particles comprises a median particle diameter equal to or greater than 40 microns.

13. The cleaning detergent of claim 11, wherein the one or more components of the gas turbine engine comprise at least one of a compressor, a high-pressure turbine, a low-pressure turbine, a combustion chamber, a nozzle, one or more blades, a booster, or a casing of the gas turbine engine.

14. A method for in-situ cleaning one or more components of a gas turbine engine, the method comprising:
providing a dry detergent into the gas turbine engine, the dry detergent comprising a plurality of detergent particles having varying particle sizes, the plurality of detergent particles comprising a first set of particles comprising a median particle diameter equal to or less than 10 microns and a second set of particles comprising a median particle diameter equal to or greater than 40 microns;
circulating the first set of particles through one or more cooling passageways of one or more of the components of the gas turbine engine, and
circulating the second set of particles across one or more of the components of the gas turbine engine.

15. The method of claim 14, wherein providing the dry detergent into the gas turbine engine further comprises injecting the dry detergent into at least one of an inlet of the gas turbine engine or one or more ports of the gas turbine engine.

16. The method of claim 15, wherein circulating the first set of particles and the second set of particles further comprises motoring the gas turbine engine during injection of the dry detergent so as to provide airflow that circulates the particles through the gas turbine engine.

17. The method of claim 15, wherein circulating the first set of particles and the second set of particles further comprises utilizing one or more external pressure sources to provide airflow that circulates the particles through the gas turbine engine.

18. The method of claim 14, further comprising activating, via a fluid, the dry detergent after circulating the first and second sets of particles through the gas turbine engine.

19. The method of claim 18, further comprising rinsing the dry detergent after activation.

20. The method of claim 15, further comprising injecting a fluid into the gas turbine engine prior to injecting the dry detergent into the gas turbine engine so as to wet one or more surfaces of the components of the gas turbine engine.
